(19) United States
(12) Patent Application Publication
(10) Pub. No.: US 2026/0159057 A1
(43) Pub. Date: Jun. 11, 2026

(54) ELECTRONIC BRAKE DEVICE

(71) Applicant: DAEGU GYEONGBUK INSTITUTE OF SCIENCE AND TECHNOLOGY, Daegu (KR)

(72) Inventors: Tae Sang PARK, Daegu (KR); Choong Pyo JEONG, Daegu (KR); Sung Ho JIN, Daegu (KR)

(21) Appl. No.: 18/716,611

(22) PCT Filed: May 2, 2023
(86) PCT No.: PCT/KR2023/005945

§ 371 Date: Jun. 5, 2024

(30) Foreign Application Priority Data
Jan. 20, 2023 (KR) 10-2023-0008906

(51) Int. Cl. B60T 13/74; F16D 55/02; F16D 65/18; F16D 121/24; F16D 125/50; F16D 125/52

(52) U.S. Cl. CPC B60T 13/746; F16D 55/02; F16D 65/183; F16D 2121/24; F16D 2125/50; F16D 2125/52

(57) ABSTRACT

The present disclosure provides an electronic brake device including a driving unit which provides a driving force for braking a disk, a power distribution unit which is connected to the driving unit and divides the driving force into a first driving force and a second driving force, a first pressing unit connected to the power distribution unit to transmit the first driving force to the disk, a second pressing unit connected to the power distribution unit to transmit the second driving force to the disk, and a pressing pad connected to the first pressing unit and the second pressing unit to transmit a braking force to the disk, wherein the power distribution unit includes a planetary gear unit connected to the driving unit, a carrier unit connected to the planetary gear unit to provide the first driving force to the first pressing unit, and a ring gear unit connected to the planetary gear unit to provide the second driving force to the second pressing unit.

### TECHNICAL FIELD

The present disclosure relates to an electronic brake device.

### BACKGROUND ART

In vehicle brakes, by using a frictional force, kinetic energy is converted into heat energy to generate a braking force, and in general, a pad presses both sides of a disk that rotates with a wheel of a vehicle.

Such vehicle brakes are used to slow down or stop a traveling vehicle or used to maintain a stop state of a parked vehicle. Among the vehicle brakes, a parking brake called a hand brake or side brake is provided in a vehicle to maintain a state of a parked vehicle.

Generally, a parking brake is operated by operating a parking lever provided at one side of a driver seat inside a vehicle. For example, when a driver pulls a parking lever, while a cable connected to the parking lever is pulled, a rear wheel brake assembly connected to the cable is operated to generate a braking force. Conversely, when the driver returns the parking lever to the original position thereof, while the cable is loosened, the braking force disappears.

Since the operation of a parking brake using a parking lever is performed by a driver, when the driver inadvertently parks a vehicle without operating the parking brake, the vehicle may move unintentionally to cause an accident. Since the parking lever should be pulled with a certain amount of force to operate the parking brake, operating the parking brake may be cumbersome for vehicle drivers.

Accordingly, recently, electronic parking brakes (EPBs) for electronically controlling the operation of a parking brake have been applied to vehicles.

Instead of a driver pulling a parking lever to apply a parking brake, in EPBS, through the driver simply operating a switch or an instruction from an electronic control unit (ECU) that serves to control a vehicle, a motor is driven to operate the parking brake.

Examples of such EPBs include electro-hydraulic brakes (EHBs) and electro-mechanical brakes (EMBs).

EHBs are configured to generate a braking force using hydraulic cylinders and pistons, and EMBs are configured to generate a braking force using motors and gears.

EHBs have disadvantages in that hydraulic devices have a complex configuration and there is a limit to the reliability of braking performance, but EMBs have a relatively simple configuration and are capable of securing the reliability of braking performance.

In the case of an EMB, an ECU detects a braking situation and transmits a braking signal to the EMB, and in the EMB, motors and gears are operated based on the transmitted signal to displace a pad and press both sides or one side of a disk, thereby generating a braking force. The braking force may be released by reversely operating a motor gear.

In EPBs, one motor, which is used to generate and release a braking force, is provided to simplify a device configuration, and when an electronic brake device includes two or more pistons, power should be distributed uniformly to each of two or more pistons when one motor is used.

In the past, a number of parts should be provided to distribute power uniformly to a plurality of pistons, or a differential gear including a relatively large capacity shaft should be provided, and thus there has been a problem that a compact design of a brake system is difficult.

### DETAILED DESCRIPTION OF THE DISCLOSURE

### Technical Problem

The present disclosure provides an electronic brake device in which a planetary gear unit divides a driving force into a first driving force and a second driving force to distribute the first driving force and the second driving force to a first pressing unit and a second pressing unit, thereby applying the uniform braking force to a disk through a plurality of piston units.

### Technical Solution to Problem

As aspect of the present disclosure provides an electronic brake device including a driving unit which provides a driving force for braking a disk, a power distribution unit which is connected to the driving unit and divides the driving force into a first driving force and a second driving force, a first pressing unit connected to the power distribution unit to transmit the first driving force to the disk, a second pressing unit connected to the power distribution unit to transmit the second driving force to the disk, and a pressing pad connected to the first pressing unit and the second pressing unit to transmit a braking force to the disk, wherein the power distribution unit includes a planetary gear unit connected to the driving unit, a carrier unit connected to the planetary gear unit to provide the first driving force to the first pressing unit, and a ring gear unit connected to the planetary gear unit to provide the second driving force to the second pressing unit.

### Advantageous Effects of the Disclosure

In an electronic brake device according to an embodiment of the present disclosure, through a sun gear connected to a driving unit, a planetary gear unit engaged with and connected to the sun gear, a carrier unit connected to one side of the planetary gear unit, and a ring gear engaged with and connected to the planetary gear unit, a driving force is distributed uniformly to a plurality of piston units, thereby obtaining an effected of improving a braking effect of a brake.

### BRIEF DESCRIPTION OF DRAWINGS

FIG. 1 is a perspective view of an electronic brake device according to an embodiment of the present disclosure.

FIG. 2 is a plan view of the electronic brake device according to an embodiment of the present disclosure.

FIG. 3 is an exploded view of the electronic brake device according to an embodiment of the present disclosure.

FIGS. 4A, 4B, and 4C are exploded views for describing an operation principle of a power distribution unit and first and second pressing units according to an embodiment of the present disclosure.

FIG. 5 is a front view of the power distribution unit and the first and second pressing units according to an embodiment of the present disclosure.

### BEST MODE

As aspect of the present disclosure provides an electronic brake device including a driving unit which provides a driving force for braking a disk, a power distribution unit which is connected to the driving unit and divides the driving force into a first driving force and a second driving force, a first pressing unit connected to the power distribution unit to transmit the first driving force to the disk, a second pressing unit connected to the power distribution unit to transmit the second driving force to the disk, and a pressing pad connected to the first pressing unit and the second pressing unit to transmit a braking force to the disk, wherein the power distribution unit includes a planetary gear unit connected to the driving unit, a carrier unit connected to the planetary gear unit to provide the first driving force to the first pressing unit, and a ring gear unit connected to the planetary gear unit to provide the second driving force to the second pressing unit.

In addition, the planetary gear unit may include a plurality of planetary gears rotating around axes spaced apart from each other on the same plane.

In addition, the power distribution unit may further include a sun gear which is engaged with and connected to each of the plurality of planetary gears and is capable of transmitting the driving force from the driving unit to the planetary gear unit.

In addition, the first pressing unit may include a first piston unit which applies the first driving force to one area of the pressing pad, and a first power transmission unit which transmits the first driving force from the power distribution unit to the first piston unit, and the first power transmission unit may include a first driving gear rotating coaxially with the carrier unit, and a first driven gear engaged with and connected to the first driving gear.

In addition, a rotation axis of the first prime gear and a rotation axis of the first driven gear may be spaced apart from each other by a preset interval, and a movement axis of the first piston unit may be coaxial with the rotation axis of the first driven gear.

In addition, the second pressing unit may include a second piston unit which applies the second driving force to one area of the pressing pad, and a second power transmission unit which transmits the second driving force from the power distribution unit to the second piston unit.

In addition, the second power transmission unit may include a second driven gear engaged with and connected to the ring gear.

In addition, the second power transmission unit may include a second driving gear engaged with and connected to the ring gear, and a second driven gear engaged with and connected to the second driving gear.

In addition, the second power transmission unit may include a second driving gear engaged with and connected to the ring gear, a reduction gear connected to one side of the second driving gear and rotating coaxially with the second driving gear, and a second driven gear engaged with and connected to the reduction gear.

Another aspect of the present disclosure provides an electronic brake device including a driving unit which provides a driving force for braking a disk, a power distribution unit which is connected to the driving unit and divides the driving force into a first driving force and a second driving force, a pressing pad which applies a braking force to the disk, a first pressing unit which receives the first driving force from the power distribution unit and applies a first pressing force to the pressing pad, and a second pressing unit which receives the second driving force from the power distribution unit and applies a second pressing force to the pressing pad, wherein, when magnitudes of the first pressing force and the second pressing force are different, the power distribution unit transmits only one of the first driving force and the second driving force to the first pressing unit or the second pressing unit until the magnitudes of the first pressing force and the second pressing force are equal to each other.

Another aspect of the present disclosure provides an electronic brake device including a driving unit which provides a driving force for braking a disk, a power distribution unit which is connected to the driving unit and divides the driving force into a first driving force and a second driving force, a pressing pad which applies a braking force to the disk, a first pressing unit which receives the first driving force from the power distribution unit and applies a first pressing force to the pressing pad, and a second pressing unit which receives the second driving force from the power distribution unit and applies a second pressing force to the pressing pad, wherein the power distribution unit transmits the first driving force to the first pressing unit and transmits the second driving force to the second pressing unit, when the first pressing force is greater than the second pressing force, a magnitude of the second driving force is greater than a magnitude of the first driving force until the magnitudes of the first pressing force and the second pressing force are equal to each other, and when the second pressing force is greater than the first pressing force, the magnitude of the first driving force is greater than the magnitude of the second driving force until the magnitudes of the first pressing force and the second pressing force are equal to each other.

### Mode of Disclosure

Since the present disclosure can apply various transformations and have various embodiments, specific embodiments will be illustrated in the drawings and described in detail in the detailed description. The effects and features of the present disclosure and methods of accomplishing the same will become apparent from the following description of the embodiments in detail, taken in conjunction with the accompanying drawings. However, the present disclosure is not limited to the embodiments disclosed below and may be implemented in various forms.

Hereinafter embodiments of the present disclosure will be described in detail with reference to the accompanying drawings, wherein like reference numerals refer to the same or corresponding components throughout the drawings, and a redundant description thereof will be omitted.

In the following embodiments, the expressions used in the singular such as “a,” “an,” and “the” are intended to include the plural forms as well, unless the context clearly indicates otherwise.

In the following embodiments, it will be understood that the terms such as “including,” “comprising,” and “having” specify the presence of stated features or components, but do not preclude the presence or addition of one or more other features or components.

When a certain embodiment may be implemented differently, a specific process order may be performed differently from the described order. For example, two consecutively described processes may be performed substantially at the same time or performed in an order opposite to the described order.

In the drawings, components may be exaggerated or reduced in size for convenience of description. For example, the sizes and thicknesses of the respective components shown in the drawings are arbitrarily shown for convenience of description, and thus the following embodiments are not necessarily limited thereto.

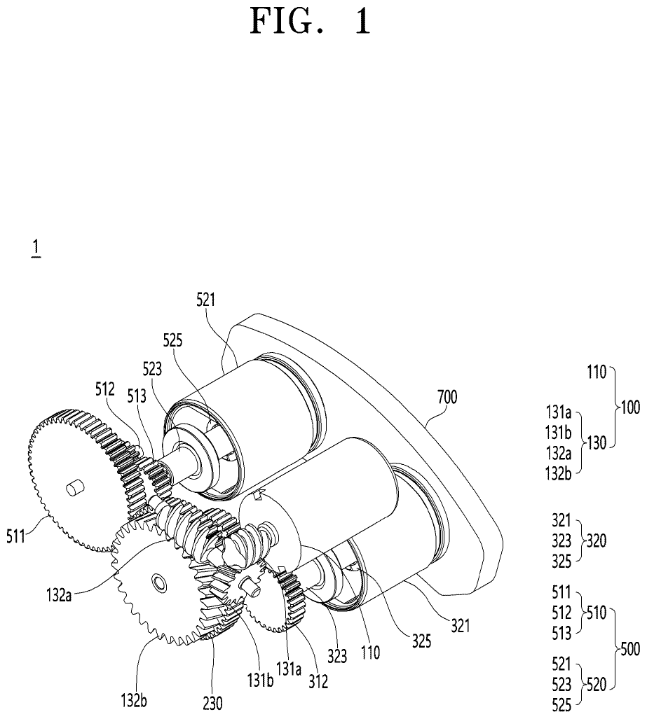

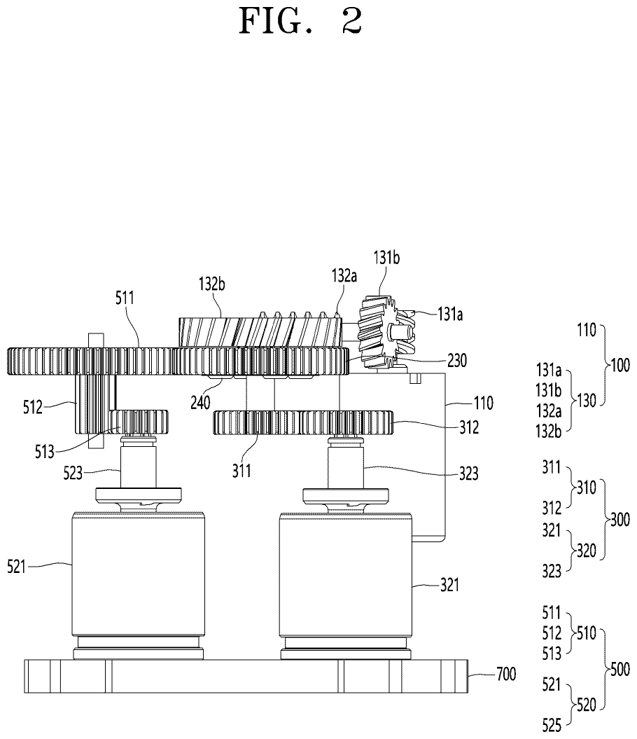

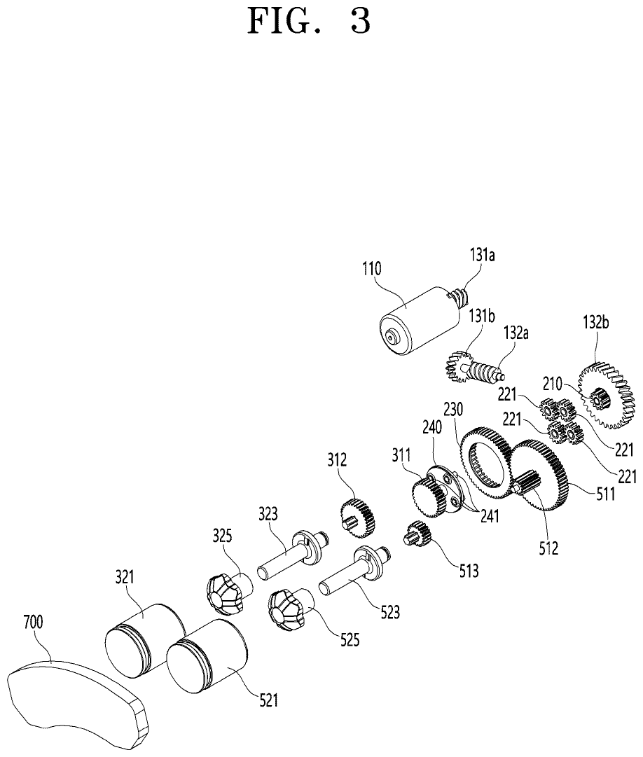

FIG. 1 is a perspective view of an electronic brake device according to an embodiment of the present disclosure. FIG. 2 is a plan view of the electronic brake device according to an embodiment of the present disclosure. FIG. 3 is an exploded view of the electronic brake device according to an embodiment of the present disclosure.

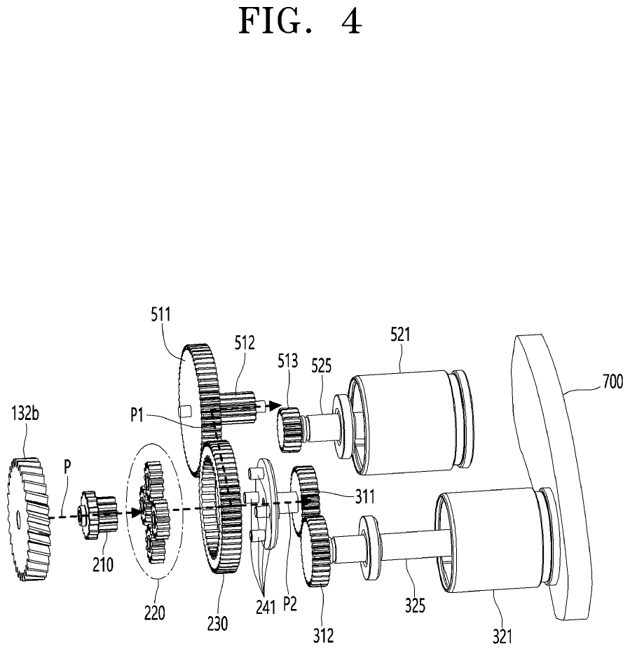

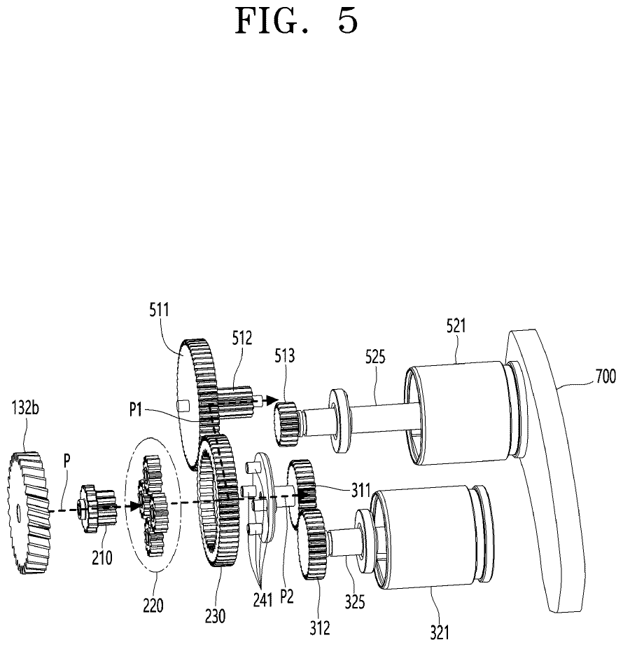

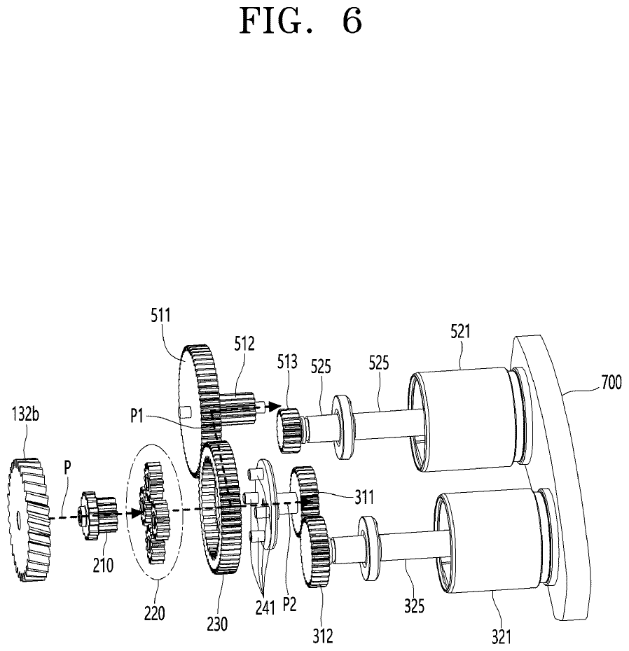

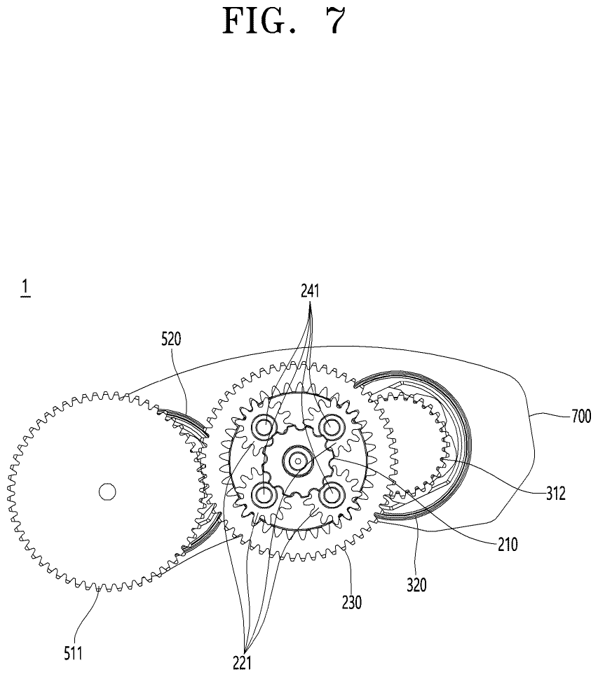

FIGS. 4A, 4B, and 4C are exploded views for describing an operation principle of a power distribution unit and first and second pressing units according to an embodiment of the present disclosure. FIG. 5 is a front view of the power distribution unit and the first and second pressing units according to an embodiment of the present disclosure.

Referring to FIGS. 1 to 3, an electronic brake device 1 according to an embodiment of the present disclosure may include a driving unit 100, a power distribution unit 200, a first pressing unit 300, a second pressing unit 500, and a pressing pad 700.

The driving unit 100 may provide a driving force P for braking a disk and may include a driving motor 110 and a driving gear unit 130.

The driving motor 110 according to an embodiment of the present disclosure may be a device that receives power from the outside and generates the driving force P and may be provided as any type of power device such as a direct current (DC) motor or a step motor which is capable of generating the driving force P by receiving a current from the outside. Furthermore, the driving motor 110 may have a great rotational torque for improved braking force and may have high revolutions per minute (RPM) for improved responsiveness. Since the driving motor 110 is applied to the electronic brake device 1 of a related art in various structures, a detailed description of the internal configuration and operation principle of the driving motor 110 will be omitted.

The driving motor 110 may provide a first direction driving force P or a second direction driving force P which corresponds to a direction of a current applied to the driving motor 110. In this case, the first direction driving force P and the second direction driving force P may have opposite rotation directions with respect to the same rotation axis, but the present disclosure is not limited thereto. When the first direction driving force P and the second direction driving force P have rotation directions to rotate around different rotation axes, the first direction driving force P and the second direction driving force P may be set to have rotation directions that forms a preset angle.

In an embodiment, when the driving motor 110 provides the first direction driving force P, the first pressing unit 300 and the second pressing unit 500, which will be described below, may apply a first pressing force and a second pressing force to the pressing pad 700, and the driving motor 110 may provide the second direction driving force P to remove the first and second pressing forces applied to the pressing pad 700. Hereinafter the driving force P defined herein may refer to the first direction driving force P, but the present disclosure is not limited to the first direction driving force P. The same may be applied even when the driving motor 110 provides the second direction driving force P.

Referring to FIGS. 1 to 3, the driving gear unit 130 according to an embodiment of the present disclosure may transmit the driving force P from the driving motor 110 to the power distribution unit 200 to be described below and may include a first driving shaft 131a, a first driving gear 131b, a second driving shaft 132a, and a second driving gear 132b.

In an embodiment, the first driving shaft 131a may be connected to one side of the driving motor 110 to transmit the driving force P to the first driving gear 131b and may be formed in a shape of a shaft with a thread formed on an outer peripheral surface.

In an embodiment, the first driving gear 131b may be engaged with and connected to the thread formed on the outer peripheral surface of the first driving shaft 131a and may be formed in a shape of a gear that transmits the driving force P from the first driving gear 131b to the second driving shaft 132a.

In an embodiment, the second driving shaft 132a may be formed in a shape of a shaft with a thread formed on an outer peripheral surface and may receive the driving force P from the first driving gear 131b to transmit the driving force P to the second driving gear 132b.

In an embodiment, the second driving gear 132b may be engaged with and connected to the thread formed on the outer peripheral surface of the second driving shaft 132a and may be formed in a shape of a gear that transmits the driving force P from the second driving gear 132b to the power distribution unit 200.

In an embodiment, the first driving shaft 131a and the first driving gear 131b may be provided as a pair of a worm and a worm gear. As a result, the first driving shaft 131a and the first driving gear 131b transmit the driving force P provided from the driving motor 110 to the second driving shaft 132a or the second driving gear 132b and serve as a reduction gear that provides a large reduction ratio, thereby obtaining an effect of precisely controlling a rotational angular speed of gears constituting the power distribution unit 200 and simultaneously increasing torque provided to the power distribution unit 200 to increase a breaking force applied to a disk.

In an embodiment, the second driving shaft 132a and the second driving gear 132b may be provided as a pair of a worm and a worm gear. As a result, the second driving shaft 132a and the second driving gear 132b transmit the driving force P provided from the driving motor 110 to the power distribution unit 200 and serve as a reduction gear that provides a large reduction ratio, thereby obtaining an effect of precisely controlling a rotational angular speed of the gears constituting the power distribution unit 200 and simultaneously increasing torque provided to the power distribution unit 200 to increase a breaking force applied to the disk.

In addition, since the driving gear unit 130 includes two consecutive pairs of worm gears including a pair of worm gears consisting of the first driving shaft 131a and the first driving gear 131b and a pair of worm gears consisting of the second driving shaft 132a and the second driving gear 132b, as compared with a case in which the driving gear unit 130 includes a pair of worm gears, relatively greater torque may be provided to the power distribution unit 200, the first and second pressing units, the pressing pad 700, or the disk, thereby increasing a braking effect of the electronic brake device 1.

In another embodiment, the driving gear unit 130 may include a pair of worm gears. For example, the driving gear unit 130 may include the first driving shaft 131a connected to the driving motor 110 and the first driving gear 131b connected directly to the power distribution unit 200.

In another embodiment, the driving gear unit 130 may include a pair of helical gears or a pair of bevel gears. Furthermore, the driving gear unit 130 may include a belt-gear pair, and thus the driving gear unit 130 may have various configurations within the technical idea capable of transmitting the driving force P provided from the driving motor 110 to the power distribution unit 200 and simultaneously having a reduction gear ratio.

Referring to FIGS. 3 to 4C, the power distribution unit 200 according to an embodiment of the present disclosure may be connected to the driving unit 100 to divide the driving force P into the first driving force P1 and the second driving force P2 and may include a sun gear 210, a planetary gear unit 220, a ring gear 230, and a carrier unit 240.

The sun gear 210 may transmit the driving force P from the driving unit 100 to the planetary gear unit 220 and may be engaged with and connected to each of a plurality of planetary gears 221 which will be described below.

In an embodiment, the sun gear 210 may be connected to one side of the second driving gear 132b and may be rotated coaxially with the second driving gear 132b.

In an embodiment, the sun gear 210 may be inserted into one side of the second driving gear 132b, and in another embodiment, the sun gear 210 may be formed integrally with the second driving gear 132b.

In another embodiment, the sun gear 210 may be connected directly to the first driving shaft 131a or the second driving shaft 132a.

In an embodiment, the sun gear 210 may be provided as one sun gear 210. Specifically, the sun gear 210 may be disposed to be rotatable coaxially with each of the second driving gear 132b, the ring gear 230, and the carrier unit 240, and the driving force P may be distributed to each of the ring gear 230 and the carrier unit 240 with only one sun gear 210, thereby obtaining an effect of reducing the number of parts and weight of the electronic brake device 1.

The planetary gear unit 220 according to an embodiment of the present disclosure may be connected to the driving unit 100 to serve to distribute the driving force P and may include the plurality of planetary gears 221.

In an embodiment, the plurality of planetary gears 221 may each be engaged with and connected to the sun gear 210 to receive the driving force P from the sun gear 210.

In an embodiment, the plurality of planetary gears 221 may receive the driving force P from the sun gear 210 to rotate coaxially with the sun gear 210 (hereinafter the rotation of the planetary gear rotating coaxially with the sun gear will be referred to as first rotation). Each planetary gear 221 may rotate using each of shafts 241 for the planetary gears 221, which will be described below, as a rotation shaft, (hereinafter the rotation of the planetary gear 221 rotating using the shaft 241 of the planetary gear 221 as the rotation shaft will be referred to as second rotation).

In an embodiment, the first rotation and the second rotation may occur simultaneously, when a first pressing force to be described below is relatively greater than a second pressing force, only the second rotation may occur, and when the second pressing force is relatively greater than the first pressing force, the first rotation and the second rotation may occur simultaneously.

In an embodiment, the electronic brake device 1 may include one planetary gear unit 220. Specifically, the planetary gear unit 220 may include the plurality of planetary gears 221 rotating around axes spaced apart from each other on the same plane.

The plurality of planetary gears 221 are positioned on a plane perpendicular to a rotation axis of the sun gear 210 or the ring gear 230 and may be rotate around the axes spaced apart from each other. Thus, unlike a double planetary gear system including a planetary gear sets positioned on different planes for uniform power distribution, by providing one planetary gear set including a plurality of planetary gears positioned on the same plane, while a function of uniformly distributing power to a plurality of pistons is maintained, there may be unique effects of reducing the number of parts of the electronic brake device 1, reducing the manufacturing costs thereof, reducing the weight thereof, and securing ease of the maintenance or repair hereof.

Referring to FIGS. 3 to 4C, the power distribution unit 200 according to an embodiment of the present disclosure may be provided as one power distribution unit 200. As a result, there is an effect in which the driving force P may be divided into the first driving force P1 and the second driving force P2 by using only one power distribution unit 200 including one sun gear 210, one planetary gear unit 220, and one ring gear 230.

The ring gear may be connected to the planetary gear unit 220 to provide the second driving force P2 to the second pressing unit 500 to be described below, and gear teeth may be formed on each of an inner peripheral surface and an outer peripheral surface thereof.

In an embodiment, the inner peripheral surface of the ring gear 230 may be engaged with outer peripheral surfaces of the plurality of planetary gears 221, and the outer peripheral surface of the ring gear 230 may be engaged with and connected to a second driving gear 511 which will be described below.

In an embodiment, the rotation axis of the ring gear 230 may be coaxial with the rotation axis of the sun gear 210 or a first rotation axis of the planetary gear unit 220.

In an embodiment, the ring gear 230 may rotate by receiving the second driving force P2 from the planetary gear unit 220. Specifically, the ring gear 230 may rotate by receiving the second driving force P2 from the planetary gear unit 220 due to the first rotation of the planetary gear 221, may rotate by receiving the second driving force P2 from the planetary gear unit 220 due to the second rotation, and may rotate by receiving the second driving force P2 from the planetary gear unit 220 due to the first and second rotations occurring simultaneously.

In an embodiment, the ring gear 230 may rotate using the same axis on the same plane as the sun gear 210 as a rotation axis.

In an embodiment, the ring gear 230 may transmit the second driving force P2 to a second power transmission unit 510 of the second pressing unit 500. Specifically, the ring gear 230 may receive the second driving force P2 due to the first and second rotations of the planetary gear 221 to transmit the second driving force P2 to the second power transmission unit 510.

The carrier unit 240 according to an embodiment of the present disclosure may be connected to the planetary gear unit 220 to provide the first driving force P1 to the first pressing unit 300 and may include a plurality of shafts 241 for the planetary gears 221.

In an embodiment, the carrier unit 240 may include a carrier that rotates coaxially with the sun gear 210 or the ring gear 230. Furthermore, the shafts 241 for the planetary gears 221 may be respectively connected to the planetary gears 221 and may each be connected to the carrier.

In an embodiment, the shafts 241 for the planetary gears 221 are fixedly connected to the carrier and may be rotatably connected to the planetary gears 221, respectively. Specifically, the shaft 241 for the planetary gear 221 may be a shaft for the second rotation of each planetary gear 221.

In an embodiment, the carrier unit 240 may receive the first driving force P1 from the planetary gear unit 220 to transmit the first driving force P1 to a first power transmission unit 310 which will be described below. Specifically, the carrier unit 240 may receive the first driving force P1 from the planetary gear unit 220 due to first direction rotation of the planetary gear 221 and may transmit the first driving force P1 due to the first direction rotation to the first power transmission unit 310.

In an embodiment, the carrier unit 240 may be rotated independently of the second rotation of the planetary gear 221. Specifically, due to the second rotation of the planetary gear 221, the second driving force P2 may be transmitted to the second pressing unit 500 through the ring gear 230, but due to the second rotation of the planetary gear 221, the first driving force P1 is not transmitted to the first pressing unit 300 through the carrier.

Referring to FIGS. 3 to 4C, the first pressing unit 300 according to an embodiment of the present disclosure may be connected to the power distribution unit 200 to transmit the first driving force P1 to the disk and may include the first power transmission unit 310 and a first piston unit 320.

The first power transmission unit 310 may receive the first driving force P1 from the power distribution unit 200 to transmit the first driving force P1 to the first piston unit 320 and may include a first driving gear 311 and a first driven gear 312.

In an embodiment, the first driving gear 311 may rotate coaxially with at least one of the sun gear 210, the ring gear 230, and the carrier unit 240 and may be formed in a shape of a gear.

In an embodiment, the first driven gear 312 may be engaged with and connected to the first driving gear 311 and may be rotated around an axis spaced apart from the rotation axis of the sun gear 210, the ring gear 230, and the carrier unit 240. Specifically, a rotation axis of the first driven gear 312 may be spaced apart from and parallel to the rotation axis of the sun gear 210. In addition, the rotation axis of the first driven gear 312 may be spaced apart from and parallel to the rotation axis of the ring gear 230. Furthermore, the rotation axis of the first driven gear 312 may be spaced apart from and parallel to the rotation axis of the carrier unit 240. In addition, the rotation axis of the first driven gear 312 may be spaced apart from and parallel to a rotation axis of the first driving gear 311.

Thus, there is an effect in which a plurality of gears are disposed on a plurality of rotation axes, thereby achieving the purpose of a compact design for the electronic brake device 1.

In addition, when the rotation axis of the first driven gear 312 is disposed coaxially with the rotation axis of the sun gear 210, the ring gear 230, and the carrier unit 240, a reaction force caused by a reaction of the first pressing force may be transmitted to the sun gear 210, the ring gear 230, or the carrier unit 240 through the first piston unit 320 and the first driven gear 312, thereby solving a problem that in addition to a mutual frictional force between the sun gear 210, the ring gear 230, and the planetary gear unit 220, the reaction force caused by the first pressing force excessively acts to reduce a function of the power distribution unit 200 implemented in the planetary gear unit 220.

As a result, the rotation axis of the first driven gear 312 is disposed to be spaced apart from the rotation axis of the sun gear 210, the ring gear 230, and the carrier unit 240 to minimize an external force (that is, the reaction of the first pressing force in an embodiment) from acting between the sun gear 210, the ring gear 230, and the planetary gear unit 220, thereby obtaining an a unique effect in which a power distribution function of the power distribution unit 200 is smoothly performed.

In an embodiment, a first gear ratio of the first driving gear 311 to the first driven gear 312 (hereinafter the first gear ratio is defined as the number of teeth of the first driving gear/the number of teeth of the first driven gear) may be less than 1. Thus, there is an effect capable of increasing a torque value of the first driving force P1 provided from the power distribution unit 200.

In another embodiment, the first driving gear 311 and the first driven gear 312 may be formed such that the first gear ratio is set to 1. In this case, there is an effect in which the first driving force P1 provided from the power distribution unit 200 and a rotational angular speed of the first driving gear 311 are transmitted to the first driven gear 312 without any change.

Referring to FIGS. 3 to 4C, the first piston unit 320 according to an embodiment of the present disclosure may apply the first driving force P1 to one area of the pressing pad 700 and may include a first piston housing 321, a first piston rod 323, and a first piston head 325.

In an embodiment, the first piston housing 321 may receive the first driving force P1 from the first piston rod 323 and the first piston head 325 to transmit the first pressing force to the pressing pad 700 and may be formed in a shape of a hollow tube.

In an embodiment, the first piston rod 323 may be connected to one side of the first driven gear 312 to transmit the first driving force P1 from the first driven gear 312 to the first piston head 325 and may be formed in a shape of a shaft.

Since the first piston unit 320 is applied to the electronic brake device 1 of a related art in various structures, a detailed description of the internal configuration and operation principle of the first piston unit 320 will be omitted below.

The second pressing unit 500 according to an embodiment of the present disclosure may be connected to the power distribution unit 200 to transmit the second driving force P2 to the disk and may include the second power transmission unit 510 and a second piston unit 520.

The second power transmission unit 510 may receive the second driving force P2 from the power distribution unit 200 to transmit the second driving force P2 to the second piston unit 520 and may include the second driving gear 511, an intermediate gear 512, and a second driven gear 513.

In an embodiment, the second driving gear 511 may receive the second driving force P2 from the ring gear 230 to transmit the second driving force P2 to the intermediate gear 512 or the second driven gear 513. The second driving gear 511 may be engaged with and connected to the ring gear 230 and may be rotated around an axis spaced apart from the ring gear 230 on the same plane.

In an embodiment, the intermediate gear 512 may be connected to one side of the second driving gear 511 and may be formed in a shape of a gear that shares a rotation axis with the second driving gear 511.

In another embodiment, the intermediate gear 512 may be formed integrally with the second driving gear 511 to be formed in a shape of a gear that shares a rotation axis with the second driving gear 511.

In an embodiment, the number of teeth of the intermediate gear 512 may be relatively less than the number of teeth of the second driving gear 511.

In an embodiment, the second driven gear 513 may be engaged with and connected to the second driving gear 511, and a rotation axis of the second driven gear 513 may be spaced apart from and parallel to a rotation axis of the second driving gear 511. In addition, the rotation axis of the second driven gear 513 may be spaced apart from and parallel to a rotation axis of the intermediate gear 512.

Thus, there is an effect in which a plurality of gears are disposed on a plurality of rotation axes, thereby achieving the purpose of a compact design for the electronic brake device 1.

In addition, when the rotation axis of the second driven gear 513 is disposed coaxially with the rotation axis of the second driving gear 511 or the intermediate gear 512, a reaction force caused by a reaction of the second pressing force may be transmitted to the second driving gear 511 or the intermediate gear 512 through the second piston unit 520 and the second driven gear 513, thereby solving a problem that an engagement connection between the second driven gear 513 and the second driving gear 511 is broken, or an engagement connection between the second driven gear 513 and the intermediate gear 512 is broken.

In an embodiment, the rotation axis of the second driven gear 513 is disposed to be spaced apart from the rotation axis of the second driving gear 511 to minimize an external force (that is, the reaction of the second pressing force in an embodiment) from acting between the second driving gear 511 and the second driven gear 513, thereby obtaining a unique effect in which a function of the ring gear 230 of transmitting power to the second power transmission unit 510 is smoothly performed.

In another embodiment, the rotation axis of the second driven gear 513 is disposed to be spaced apart from the rotation axis of the intermediate gear 512 to minimize an external force (that is, a force caused by the reaction of the second pressing force in an embodiment) from acting between the intermediate gear 512 and the second driven gear 513, thereby obtaining an a unique effect in which a function of the ring gear 230 of transmitting power to the second power transmission unit 510 is smoothly performed.

In an embodiment, a second gear ratio of the intermediate gear 512 to the second driven gear 513 (hereinafter the second gear ratio=the number of teeth of the intermediate gear/the number of teeth of the second driven gear) may be greater than 1. Thus, there is an effect capable of reducing a torque value of the second driving force P2 provided from the power distribution unit 200 and simultaneously increasing a rotational angular speed of the second driven gear 513.

In another embodiment, a third gear ratio of the second driving gear 511 to the second driven gear 513 (hereinafter the third gear ratio is defined as the number of teeth of the second driving gear/the number of teeth of the second driven gear) may be greater than 1. Thus, there is an effect capable of reducing a torque value of the second driving force P2 provided from the power distribution unit 200 and simultaneously increasing the rotational angular speed of the second driven gear 513.

The second piston unit 520 according to an embodiment of the present disclosure may apply the second driving force P2 to the other area of the pressing pad 700 and may include a second piston housing 521, a second piston rod 523, and a second piston head 525.

In an embodiment, the second piston housing 521 may receive the second driving force P2 from the second piston rod 523 and the second piston head 525 to transmit the second pressing force to the pressing pad 700 and may be formed in a shape of a hollow tube.

In an embodiment, the second piston rod 523 may be connected to one side of the second driven gear 513 to transmit the second driving force P2 from the second driven gear 513 to the second piston head 525 and may be formed in a shape of a shaft.

Since the second piston unit 520 is applied to the electronic brake device 1 of a related art in various structures, a detailed description of the internal configuration and operation principle of the second piston unit 520 will be omitted below.

The pressing pad 700 according to an embodiment of the present disclosure may be connected to the first pressing unit 300 and the second pressing unit 500 to transmit a braking force to the disk.

In an embodiment, the pressing pad 700 may be positioned on a plane perpendicular to a movement path of the first pressing unit 300 and the second pressing unit 500 and may selectively come into contact with at least one of the first pressing unit 300 and the second pressing unit 500.

In an embodiment, the pressing pad 700 may receive the first pressing force from the first pressing unit 300 to transmit a braking force to the disk, and the pressing pad 700 may receive the second pressing force from the second pressing unit 500 to transmit a braking force to the disk.

Hereinafter the operation principle and effects of the electronic brake device 1 according to an embodiment of the present disclosure described above will be described. In the present specification, the operation principle is described in time series for convenience of description, and the operation principle, the flow of the driving force P, and the like which will be described below are not limited to the specific order set forth herein and may be performed simultaneously.

The driving unit 100 may receive power from the outside to transmit the driving force P to the power distribution unit 200 through the first driving gear 131b or the second driving gear 132b, and the sun gear 210 of the power distribution unit 200 may receive the driving force P to transmit the driving force P to the planetary gear unit 220.

The plurality of planetary gears 221 receiving the driving force P may perform at least one of the first rotation and the second rotation, and the planetary gear unit 220 may perform the first rotation or the second rotation to divide the driving force P into the first driving force P1 and the second driving force P2.

Specifically, the carrier unit 240 receiving the first driving force P1 due to the first rotation of the planetary gears 221 may rotate coaxially with the sun gear 210, and the ring gear 230 receiving the second driving force P2 due to at least one of the first rotation and the second rotation of the planetary gears 221 may rotate coaxially with the sun gear 210.

In the present specification, the first pressing force refers to the pressure or force applied to the pressing pad 700 by the first pressing unit 300, specifically, the first piston unit 320. In addition, the first pressing force is a reaction of the pressure or force applied to the pressing pad 700 by the first piston unit 32 and refers to the pressure or force applied to the first piston unit 320 by the pressing pad 700.

The second pressing force refers to the pressure or force applied to the pressing pad 700 by the second pressing unit 500, specifically, the second piston unit 520. In addition, the second pressing force is a reaction of the pressure or force applied to the pressing pad 700 by the second piston unit 520 and refers to the pressure or force applied to the second piston unit 520 by the pressing pad 700.

Hereinafter a distribution flow of the driving force P in the planetary gear unit 220 will be described when magnitudes of the first pressing force and the second pressing force are each 0 or are equal to each other.

FIG. 4C illustrates a case in which the magnitude of the first pressing force is equal to the magnitude of the second pressing force in the electronic brake device 1 according to an embodiment of the present disclosure.

In this case, since each of the ring gear and the carrier unit 240 may rotate freely, the first and second rotations of the plurality of planetary gear units 220 may performed simultaneously, and thus the ring gear 230 and the carrier unit 240 may rotate coaxially with the sun gear 210. As a result, the driving force P may be divided into the first driving force P1 and the second driving force P2, and in an embodiment, the first driving force P1 and the second driving force P2 may have the same value.

Specifically, the sun gear 210 may rotate by receiving the driving force P from the driving unit 100, and the plurality of planetary gears 221 engaged with and connected to the sun gear 210 may perform the first rotation and the second rotation by receiving a rotational force of the sun gear 210 generated by the driving force P. Since the plurality of planetary gears 221 perform the first rotation with a rotational force generated by the first driving force P1, the carrier unit 240 connected to the planetary gears 221 through the shafts 241 for the planetary gears 221 may rotate to transmit the first driving force P1 to the first pressing unit 300, and since the plurality of planetary gears 221 perform the first and second rotations with a rotational force generated by the second driving force P2, the ring gear 230 engaged with and connected to the planetary gears 221 may rotate by receiving the second driving force P2. As a result, the second pressing unit 500 engaged with connected to the ring gear 230 may receive the second driving force P2.

Hereinafter a distribution flow of the driving force P in the planetary gear unit 220 when the magnitude of the first pressing force is relatively greater than the magnitude of the second pressing force will be described.

FIG. 4A illustrates a case in which the magnitude of the first pressing force is relatively greater than the magnitude of the second pressing force in the electronic brake device 1 according to an embodiment of the present disclosure.

Due to the rotational resistance of the ring gear 230 and the carrier unit 240 generated by a difference in relative magnitude between the first pressing force and the second pressing force, the carrier unit 240 may not rotate or may rotate at an angular speed that is relatively lower than a rotational angular speed of the ring gear 230.

In this case, the sun gear 210 may rotate by receiving the driving force P from the driving unit 100, and the plurality of planetary gears 221 engaged with and connected to the sun gear 210 may perform the second rotation by receiving a rotational force of the sun gear 210 generated by the driving force P. Thus, the plurality of planetary gears 221 perform the second rotation with a rotational force generated by the second driving force P2 so that the ring gear 230 engaged with and connected to the planetary gears 221 rotates by receiving the second driving force P2. Accordingly, the second pressing unit 500 engaged with and connected to the ring gear 230 may receive the second driving force P2, and due to the fixing of the carrier unit 240, it is impossible for the carrier unit 240 to perform the first rotation due to the first driving force P1 so that the planetary gear unit 220 may divide most of the driving force P into the second driving force P2. As a result, the magnitude of the second driving force P2 divided by the power distribution unit 200 may be relatively greater than the magnitude of the first driving force P1.

In another embodiment, due to the fixing of the carrier unit 240, the power distribution unit 200 may selectively transmit the driving force P to the second pressing unit 500. As a result, the magnitude of the first driving force P1 divided by the power distribution unit 200 may converge to 0.

Hereinafter a distribution flow of the driving force P in the planetary gear unit 220 when the magnitude of the second pressing force is relatively greater than the magnitude of the first pressing force will be described.

FIG. 4B illustrates a case in which the magnitude of the first pressing force is relatively less than the magnitude of the second pressing force in the electronic brake device 1 according to an embodiment of the present disclosure.

Due to the rotational resistance of the ring gear 230 and the carrier unit 240 generated by a difference in relative magnitude between the first pressing force and the second pressing force, the ring gear 230 may not rotate or may rotate at an angular speed that is relatively lower than a rotational angular speed of the carrier unit 240.

In this case, the sun gear 210 may rotate by receiving the driving force P from the driving unit 100, and the plurality of planetary gears 221 engaged with and connected to the sun gear 210 may perform the first rotation and the second rotation by receiving a rotational force of the sun gear 210 generated by the driving force P. Thus, the plurality of planetary gears 221 perform the first and second rotations with a rotational force generated by the first driving force P1 so that the carrier unit 240 connected to the planetary gears 221 through the shafts 241 for the planetary gears 221 rotates by receiving the first driving force P1. Accordingly, the first pressing unit 300 connected to the carrier unit 240 may receive the first driving force P1, and due to the fixing of the ring gear 230, it is impossible for the ring gear 230 to perform the second rotation due to the second driving force P2 so that the planetary gear unit 220 may divide most of the driving force P into the first driving force P1. As a result, the magnitude of the first driving force P1 divided by the power distribution unit 200 may be relatively greater than the magnitude of the second driving force P2.

In another embodiment, due to the fixing of the ring gear 230, the power distribution unit 200 may selectively transmit the driving force P to the first pressing unit 300. As a result, the magnitude of the second driving force P2 divided by the power distribution unit 200 may converge to 0.

The spirit of the present disclosure should not be limited to the above-described embodiments, and not only the scope of the appended claims but also all ranges equivalent to or equivalently changed from the claims are within the scope of the present disclosure.

### INDUSTRIAL APPLICABILITY

According to an embodiment of the present disclosure, an electronic brake device is provided. In addition, embodiments of the present disclosure may be applied to an electronic brake device including a plurality of pistons used industrially.

1. An electronic brake device comprising:
a driving unit which provides a driving force for braking a disk;
a power distribution unit which is connected to the driving unit and divides the driving force into a first driving force and a second driving force;
a first pressing unit connected to the power distribution unit to transmit the first driving force to the disk;
a second pressing unit connected to the power distribution unit to transmit the second driving force to the disk; and
a pressing pad connected to the first pressing unit and the second pressing unit to transmit a braking force to the disk,
wherein the power distribution unit comprises a planetary gear unit connected to the driving unit, a carrier unit connected to the planetary gear unit to provide the first driving force to the first pressing unit, and a ring gear unit connected to the planetary gear unit to provide the second driving force to the second pressing unit.

2. The electronic brake device of claim 1, wherein the planetary gear unit comprises a plurality of planetary gears rotating around axes spaced apart from each other on the same plane.

3. The electronic brake device of claim 2, wherein the power distribution unit further comprises a sun gear which is engaged with and connected to each of the plurality of planetary gears and is capable of transmitting the driving force from the driving unit to the planetary gear unit.

4. The electronic brake device of claim 3, wherein the first pressing unit comprises a first piston unit which applies the first driving force to one area of the pressing pad, and a first power transmission unit which transmits the first driving force from the power distribution unit to the first piston unit,
wherein the first power transmission unit comprises a first driving gear rotating coaxially with the carrier unit, and a first driven gear engaged with and connected to the first driving gear.

5. The electronic brake device of claim 4, wherein a rotation axis of the first driving gear and a rotation axis of the first driven gear are spaced apart from each other by a preset interval, and
a movement axis of the first piston unit is coaxial with the rotation axis of the first driven gear.

6. The electronic brake device of claim 3, wherein the second pressing unit comprises a second piston unit which applies the second driving force to one area of the pressing pad, and a second power transmission unit which transmits the second driving force from the power distribution unit to the second piston unit.

7. The electronic brake device of claim 6, wherein the second power transmission unit comprises a second driven gear engaged with and connected to the ring gear.

8. The electronic brake device of claim 6, wherein the second power transmission unit comprises a second driving gear engaged with and connected to the ring gear, and a second driven gear engaged with and connected to the second driving gear.

9. The electronic brake device of claim 6, wherein the second power transmission unit comprises a second driving gear engaged with and connected to the ring gear, a reduction gear connected to one side of the second driving gear and rotating coaxially with the second driving gear, and a second driven gear engaged with and connected to the reduction gear.

10. An electronic brake device comprising:
a driving unit which provides a driving force for braking a disk;
a power distribution unit which is connected to the driving unit and divides the driving force into a first driving force and a second driving force;
a pressing pad which applies a braking force to the disk;
a first pressing unit which receives the first driving force from the power distribution unit and applies a first pressing force to the pressing pad; and
a second pressing unit which receives the second driving force from the power distribution unit and applies a second pressing force to the pressing pad,
wherein, when magnitudes of the first pressing force and the second pressing force are different, the power distribution unit transmits only one of the first driving force and the second driving force to the first pressing unit or the second pressing unit until the magnitudes of the first pressing force and the second pressing force are equal to each other.

11. An electronic brake device comprising:
a driving unit which provides a driving force for braking a disk;
a power distribution unit which is connected to the driving unit and divides the driving force into a first driving force and a second driving force;
a pressing pad which applies a braking force to the disk;
a first pressing unit which receives the first driving force from the power distribution unit and applies a first pressing force to the pressing pad; and
a second pressing unit which receives the second driving force from the power distribution unit and applies a second pressing force to the pressing pad,
wherein the power distribution unit transmits the first driving force to the first pressing unit and transmits the second driving force to the second pressing unit,
when the first pressing force is greater than the second pressing force, a magnitude of the second driving force is greater than a magnitude of the first driving force until the magnitudes of the first pressing force and the second pressing force are equal to each other, and
when the second pressing force is greater than the first pressing force, the magnitude of the first driving force is greater than the magnitude of the second driving force until the magnitudes of the first pressing force and the second pressing force are equal to each other.
